(19) United States
(12) Patent Application Publication
(10) Pub. No.: US 2021/0057956 A1
(43) Pub. Date: Feb. 25, 2021

(54) STATOR ARRANGEMENT COMPRISING A WINDING ARRANGEMENT

(71) Applicant: ebm-papst St. Georgen GmbH & Co. KG, St. Georgen (DE)

(72) Inventors: Volker EHLERS, St. Georgen (DE); Martin KÖNIG, Herrenberg (DE); Stephan LOSCH, St. Georgen (DE)

(21) Appl. No.: 16/977,497

(22) PCT Filed: Mar. 6, 2019
(86) PCT No.: PCT/EP2019/055577

§ 371 Date: Sep. 2, 2020

(30) Foreign Application Priority Data
Mar. 8, 2018 (DE) 10 2018 105 337.1

(51) Int. Cl. H02K 3/52; H02K 3/28; H02K 3/34

(52) U.S. Cl. CPC H02K 3/522; H02K 2203/03; H02K 3/345; H02K 3/28

(57) ABSTRACT

An external stator arrangement has a stator core, a wire guiding arrangement and a winding arrangement with a winding wire. The winding arrangement is designed as a delta circuit and has a number SC of stator coils. SC=N*3 where N=1, 2, 3, 4, 5, . . . . The stator core has a magnetic return path, stator poles and slots. The wire guiding arrangement has a first contact-making arrangement, a second contact-making arrangement and a third contact-making arrangement. The winding wire runs from the first contact-making arrangement, via at least one of the stator coils, to the second contact-making arrangement, from the second contact-making arrangement, via at least one of the stator coils, to the third contact-making arrangement, and from the third contact-making arrangement, via at least one of the stator coils to the first contact making arrangement. Contact elements are electrically connected to the winding wire in order to serve as winding connections.

### CROSS-REFERENCE TO RELATED APPLICATIONS

This application is a National Stage of International Application No. PCT/EP2019/055577, filed Mar. 6, 2019 and published in German as WO 2019/170751 on Sep. 12, 2019. This application claims priority to German Patent Application No. 10 2018 105 337.1, filed Mar. 8, 2018. The entire disclosures of the above applications are incorporated herein by reference.

### FIELD

The disclosure relates to a stator arrangement with a winding arrangement.

### SUMMARY

It should be possible to produce stator arrangements at the lowest possible cost. In particular, the winding can be expensive depending on the stator design and on the type of winding. Therefore, it is an object of the disclosure to provide a novel stator arrangement.

This object is achieved by a stator arrangement that has a stator core, a wire guiding arrangement and a winding arrangement with a winding wire. It is designed as an external stator arrangement. It comprises a winding arrangement with a delta circuit and a number SC of stator coils: SC=N*3 where N=1, 2, 3, 4, 5, . . . . The stator core has a magnetic return path, stator poles and clots that are formed between the stator poles. The wire guiding arrangement has an associated first contact-making arrangement. The arrangement includes a first contact element, an associated second contact-making arrangement with a second contact element, and an associated third contact-making arrangement with a third contact element. The winding wire runs, without interruption, from the first contact-making arrangement, via at least one of the stator coils, to the second contact-making arrangement, from the second contact-making arrangement, and from the third contact-making arrangement, via at least one of the stator coils, to the first contact-making arrangement. The contact elements are electrically connected to the winding wire in order to serve as winding connections. At least one of the contact-making arrangement has a first receiving opening to receive the contact element and a second receiving opening to receive the winding wire. On a first side of the second receiving opening, at least one of the contact-making arrangements extends in an axial direction farther away from the stator core than on the second side, opposite the first side. This enables, during the winding of the winding wire, a capture of the winding wire.

An external stator arrangement has a stator core, a stator guiding arrangement and a winding arrangement with a winding wire. The winding arrangement is designed as a delta circuit and has a number SC of stator coils. SC=N*3 where N=1, 2, 3, 4, 5, . . . .

The stator core has a magnetic return path, stator poles and slots that are formed between the stator poles. The wire guiding arrangement has an associated first contact-making arrangement with a first contact element, an associated second contact-making arrangement with a second contact element, and an associated third contact-making arrangement with a third contact element. The winding wire runs without interruption from the first contact-making arrangement, via at least one of the stator coils, to the second contact-making arrangement, from the second contact-making arrangement, via at least one of the stator coils, to the third contact-making arrangement. Finally, it runs from the third contact-making arrangement, via at least one of the stator coils, to the first contact-making arrangement. The contact elements are electrically connected to the winding wire to serve as winding connections.

Thus, a simple installation is made possible. The winding wire can be used for all the stator coils. The number of the contact elements can also be reduced.

According to a preferred embodiment, the contact-making arrangements are in each case arranged offset by at least 110° with respect to one another, preferably in each case by 120°. Due to the subdivision of the contact-making arrangements, it is possible to increase the symmetry of the winding arrangement. This is particularly advantageous in the case of fast running electric motors. The symmetric resistance is particularly advantageous when a current regulator is used to actuate the winding arrangement. In the case of different resistances, a current regulator requires different voltages in order to introduce identical currents into the phases.

According to a preferred embodiment, the contact elements on the wire guiding arrangements are distributed such that a subdivision is possible of the wire guiding arrangement into three sections of 120°. A contact element is provided in each of the sections. This distribution of the contact elements enables a high degree of symmetry of the winding arrangement.

According to a preferred embodiment, the electrical resistances existing in each case between two of the contact elements differ from one another by less than 3%, preferably by less than 2%, more preferably by less than 1%, and more preferably by less than 0.5%. The electrical resistances between two contact elements in each case are a satisfactory and easily verified measure of the symmetry of the winding arrangement. The mentioned values enable an advantageous use of the winding arrangement. In particular for electric motors with high rotational speed (for example, 40,000 rpm or 50,000 rpm), but they are also advantageous for lower rotational speeds.

According to a preferred embodiment, the contact-making arrangements are arranged at least in part neither centrally with respect to one of the stator poles nor centrally with respect to one of the slots. This arrangement has been found to be advantageous for the winding. In particular, for use of a needle winder that can be immersed in the stator interior after the contact-making arrangement.

According to a preferred embodiment, the winding wire is guided in sections so that, after the winding of one of the stator poles, it is guided in one of the contact-making arrangements from radially outside to radially inside. On the radially inner side, the winding wire can thus be guided directly to a stator coil. Thus, this avoids a long winding wire and increased resistance.

According to the disclosure, at least one of the contact-making arrangements has a first receiving opening to receive the contact element and a second receiving opening to receive the winding wire. Thus, the positioning of the winding wire and of the contact element is unequivocally and precisely predetermined by the contact-making arrangement.

According to a preferred embodiment, the second receiving opening of the contact-making arrangement extends in a radial direction. The radial direction is advantageous for the winding but in principle other directions are also possible.

According to a preferred embodiment, the first receiving opening extends in an axial direction of the stator arrangement. This enables plugging in of a contact element in an axial direction.

According to a preferred embodiment, the first receiving opening extends in a direction of the stator arrangement that deviates from the axial direction. Thus, other angles between the contact element and the winding wire can be achieved. This enables an advantageous electrical connection of a larger area.

According to a preferred embodiment, the first receiving opening is designed at least in sections to pass through the second receiving opening. In particular, in the case of insulation displacement contacts, but also in the case of other contacts, a precise spatial association by means of the contact-making arrangement is advantageous.

According to the disclosure, on a first side of the second receiving opening, at least one of the contact-making arrangements extends in an axial direction farther away from the stator core than on the second side opposite the first side. This enables, during the winding of the winding wire, a capture of the winding wire. This design has led to a clear simplification of the winding process and in particular to a higher process reliability.

According to a preferred embodiment, the number N is at least 2. The winding wire runs between the contact-making arrangement via at least two of the stator coils. In this way, the winding wire can be used between two contact elements for multiple stator coils. The number of the contact elements can be kept small.

According to a preferred embodiment, the winding wire between the contact-making arrangements connects at least two of the stator coils in series. This makes possible a series connection with the winding wire.

According to a preferred embodiment, the first contact element, the second contact element and the third contact element are designed as insulation displacement contact elements. This enables a rapid and reliable contact

According to a preferred embodiment, at least two of the contact-making arrangements are identical. This facilitates the plugging in of the contact elements, and the production.

According to a preferred embodiment, the first contact element, the second contact element and the third contact element are identical. Such a formation is possible with the design and facilitates the handling and the storing with regard to the contact elements.

According to a preferred embodiment, at least two winding wires are provided, which are wound together. In the case of exactly two winding wires, one speaks of a bifilar winding. The electrical resistance is lowered. Due to the common winding, time is saved and an improved symmetry can be achieved.

According to a preferred embodiment, the wire guiding arrangement has at least one winding post. The winding wire lies against the post in order to enable a guiding of the winding wire and influencing of the length of the winding wire between two contact elements. The symmetry of the winding arrangement can be further increased by an appropriate arrangement of the winding posts.

According to a preferred embodiment, an electric motor has a corresponding stator arrangement and a rotor arrangement. Thus, the electric motor can be produced in a simple manner.

According to a preferred embodiment, a current regulator, regulating the current through the winding arrangement, is associated with the electric motor. The combination of the current regulator with the stator arrangement leads to a very advantageous electric motor.

Additional advantages, designs, features and details of the disclosure result from the following description of preferred embodiment examples and in reference to the drawings. The above-mentioned features and combinations of features as well as the individual features and combinations of features mentioned below in the description of the figures and/or shown only in the figures can be used not only in the indicated combination but also in other combinations or individually. Identical or functionally equivalent elements are associated with identical reference numerals. For the sake of clarity, the elements may not be provided with their reference numerals in all the figures, but without losing their assignment.

### DRAWINGS

The drawings described herein are for illustrative purposes only of selected embodiments and not all possible implementations, and are not intended to limit the scope of the present disclosure.

FIG. 1 is a top plan view of a stator arrangement with a stator core;

FIG. 2 is a cross section view of an electric motor with a rotor and with the stator arrangement of FIG. 1;

FIG. 3 is a top plan view of a first axial side of the stator arrangement of FIG. 2;

FIG. 4 is a top plan view of a second axial side of the stator arrangement of FIG. 2;

FIG. 5 is a side elevation view of the stator arrangement of FIG. 2;

FIG. 6 is an enlarged detail view of VI of FIG. 3;

FIG. 7 is an enlarged detail view of VII of FIG. 3;

FIG. 8 is a side elevation view like FIG. 5 or a first step of a winding process;

FIG. 9 is a side elevation view like FIG. 5 or a second step of a winding process;

FIG. 10 is a longitudinal cross section view of a contact-making arrangement with a contact element;

FIG. 11 is a longitudinal cross-section view of the contact-making arrangement with the contact element of FIG. 10;

FIG. 12 is a schematic view of the winding wiring plan of the stator arrangement of FIG. 3;

FIG. 13 is a schematic view of the winding wiring plan of the stator arrangement of FIG. 3; and

FIG. 14 is an enlarged detail view of FIG. 7 with bifilar winding.

### DETAILED DESCRIPTION

FIG. 1 shows a stator arrangement 20 with a stator core 22 designed as a stator lamination stack or as a sintered component. The stator core 22 has a plurality of stator poles 32. Slots 34 are formed between the poles 32. Preferably, the stator core 22 has a magnetic return path 30 that magnetically connects the stator poles 32 to one another.

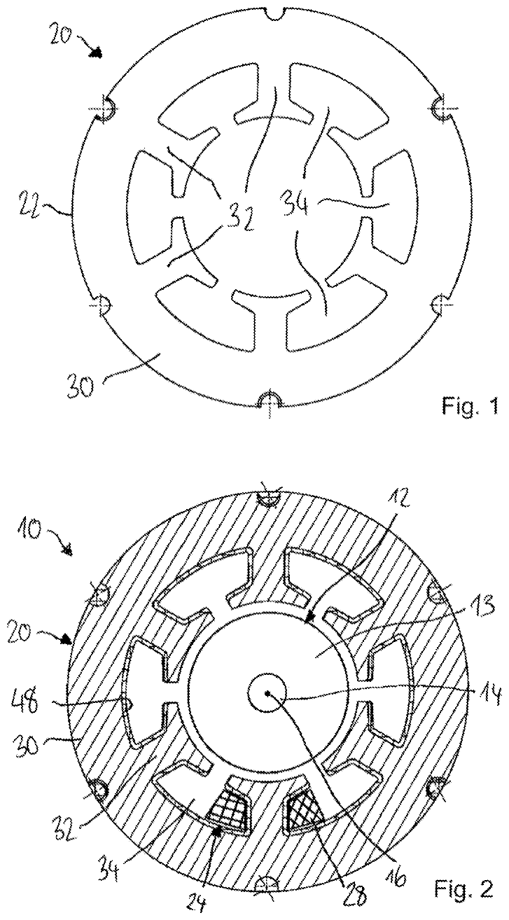

FIG. 2 diagrammatically shows an electric motor 10 with the stator arrangement 20 and a rotor arrangement 12. The rotor arrangement 12 has a rotor 13 and a diagrammatically represented bearing arrangement 14. The rotor 13 is rotatably mounted about a rotation axis 16. The bearing arrangement 14 has, for example, a sliding bearing, a roller bearing or a magnetic bearing, and the rotor 13 is, for example, a permanent magnetic rotor or a cage rotor. The rotation axis 16 defines an axial direction and a radial direction of the electric motor 10 or of the stator arrangement 20.

A slot insulation 48 is provided for insulating the stator slots 34.

A stator coil 28 of a winding arrangement 24 is diagrammatically represented. The stator coils 28 can be provided in the area of the slots 34 around the stator poles 32.

The stator arrangement 20 is preferably designed as an external stator arrangement. The rotor arrangement 12 is an internal rotor arrangement. However, a combination of an internal stator arrangement and an external rotor arrangement is also possible.

The stator core 22 preferably has an external diameter of 35 mm; however, the external diameter can also be, for example, 30 mm or 50 mm or have a value in between.

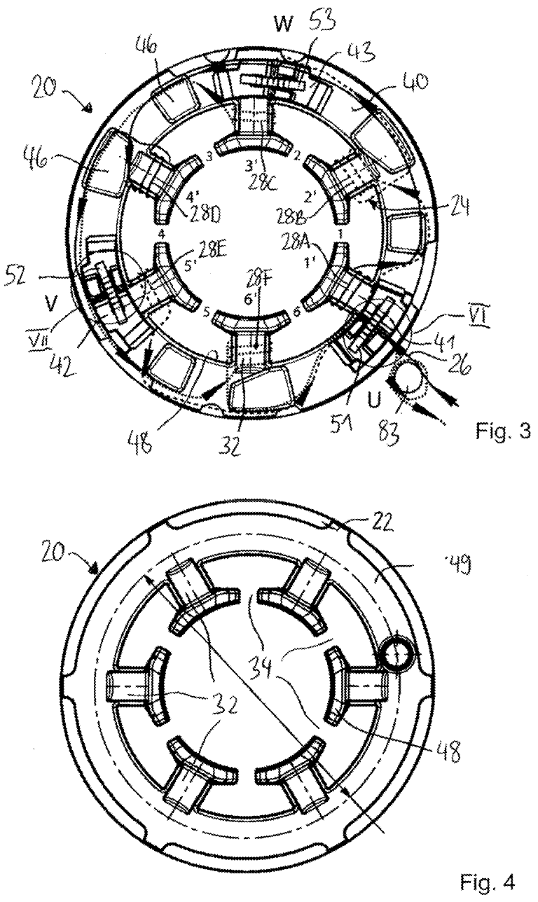

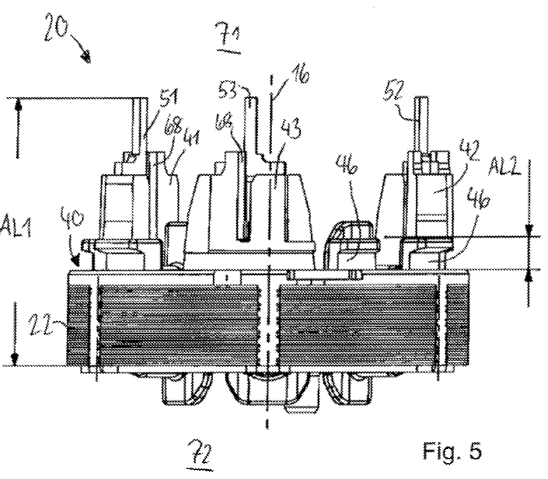

FIG. 3 shows a first axial side 71 (compare FIG. 5) of the stator arrangement 20 of FIG. 2. in a top plan view. A wire guiding arrangement 40 is on the first axial side 71 of the stator core 22. The wire guiding arrangement 40 is preferably designed at least on its outer side to be electrically nonconductive, for example made of plastic, for example. In the embodiment example, the wire guiding arrangement 40 also extends into the area of the stator pole 32. This, at least in part, provides the slot insulation 48 for the winding arrangement 24. However, the insulation between the stator core 22 and the winding arrangement 24 can also occur by an additional component, for example, a plastic shell or insulation paper.

The wire guiding arrangement 40 has a first contact-making arrangement 41 with a first contact element 51, a second contact-making arrangement 42 with a second contact element 52, and a third contact-making arrangement 43 with a third contact element 53.

The winding arrangement 24 has a winding wire 26 that runs without interruption from the first contact-making arrangement 41, via the stator coils 28A, 28D, to the second contact-making arrangement 42. Also it runs from the second contact-making arrangement 42, via the stator coils 28E, 28B, to the third contact-making arrangement 43. Further, it runs from the third contact-making arrangement 43, via the stator coils 28C, 28F, back to the first contact-making arrangement 41.

Thus, in the case of a six-pole stator, in each case the mutually opposite stator coils are actuated by one of the three phases. For a better understanding, the winding wire 26 is represented with a continuous line between the first contact-making arrangement 41 and the second contact-making arrangement 42. A loosely dashed line is between the second contact-making arrangement 42 and the third contact-making arrangement 43. A densely dotted line is between the third contact-making arrangement 43 and the first contact-making arrangement 41.

A winding post 83 is represented, on which the winding wire 26 can be secured at the beginning and at the end of the winding process, for example, by a few turns around the winding posts. The winding post is preferably associated with a winding device. Particularly preferably, a needle winder device can be used as winding device.

After the application of the contact elements 51, 52, 53, the winding wire 26 is secured in the winding arrangement. The two wire ends are cut off, for example, on the radially outer side of the first contact-making arrangement 41. Subsequently, the winding post 83 can be removed, and only two short pieces of wire remain as waste. This is very environmentally friendly, and due to the high purity of type (preferably clean enameled wire without additional plastic waste from the wire guiding arrangement) it can easily be recycled. The winding post can alternatively already be removed before cutting off the wire ends or already before the setting of the contact elements 51, 52, 53.

A six-pole or six-slot stator core 22 is represented. In a three-pole stator core 22, the winding wire 26 would accordingly form in each case a single stator coil 28 between two of the contact-making arrangements 41, 42, 43. In a stator with a larger number of poles with, for example, 9, 12, 15 or 18 stator poles 32, a larger number of coils between each two of the contact arrangements 41, 42, 43 would accordingly be formed with the winding wire 26.

The disclosure is well suited for a number SC of stator poles 32 or stator coils 28, for which the number SC is:

SC=N*3 where N=1,2,3,4,5, . . . .

In other words, the number SC of stator coils 28 is three or a multiple of three. Preferably, the value of N is at least two.

The contact elements 51, 52, 53 are preferably in each case electrically connected to the winding wire 26. Thus they serve as winding connections or phase connections. The electrical connection can be brought about, for example, by a soldering connection. However, it is particularly preferable to form an electrical and mechanical connection by forming the contact elements 51, 52, 53 as insulation displacement contact elements.

In the embodiment example, the contact-making arrangements 41, 42, 43 are arranged offset by 120°, with respect to one another. Thus, if one rotates the stator arrangement 20 by 120°, a contact-making arrangement 41, 42, 43 is positioned at the same sites as before the rotation. This equal distribution of the contact-making arrangements 41, 42, 43 or of the contact elements 51, 52, 53 is advantageous. Accordingly, it is easier to design the wire lengths between the individual contact-making arrangements 41, 42, 43 so that they are approximately the same length as in an arrangement where the contact-making arrangements 41, 42, 43 are arranged next to one another. Equal wire lengths between the contact-making arrangements 41, 42, 43 lead to the resistance of the winding wire 26 between each two adjacent contact-making arrangements 41, 42, 43 being approximately the same. This results in a symmetric curve of the voltages and currents. Thus, in particular, at high rotational speeds such as, for example, 60,000 rpm, the electric motor 10 works better. The term resistance is used as synonym for electrical resistance.

The wire lengths of the winding wire 26 between the contact elements 51, 52, 53 are relevant to the electrical resistance of the winding arrangement 24. However, on the one hand, the wiring lengths can only be measured with difficulty since the winding arrangement has to be undone for this purpose. On the other hand, the electrical resistance also depends on the tension that the winding wire 26 is wound. With high tension, the winding wire 26 becomes thinner and has a greater electrical resistance. The symmetry of the winding can thus be determined in a simple way in that the resistance between the individual winding connections is measured, for example, by measuring the electrical resistance between the contact elements 51, 52 or 52, 53 or 53, 51. In these measurements, the measured electrical resistance is determined, on the one hand, via the phase in the direct connection. On the other hand, it is also measured via the other two series-connected phases. Thus, for example, in the case of a measurement of the resistance between the contact elements 51, 52, the resistance of a parallel connection of the winding wire section arranged directly between the contact elements 51, 52 and the winding section running from the contact element 51 via the contact element 53 to the contact element 52 is measured. The measurement preferably occurs in the non-rotating state or without a rotor, in order to prevent an influence due to induced voltage resulting from the rotation.

For the evaluation of the symmetry, the aforementioned resistances between the contact elements 51-52, 52-53 and 53-51 can be measured. Thus, these determined electrical resistances differ preferably by less than 3%, more preferably by less than 2%, more preferably by less than 1%, and more preferably by less than 0.5%. These values result in a good flow pattern in the winding arrangement 24. Thus, high rotational speeds can also be achieved. In the determination of the differences, in each case, the percentage difference between the two determined resistance values is calculated. Thus, the difference is calculated between the resistance between the first contact-making arrangement 41 and the second contact-making arrangement 42 as well as the resistance between the second contact-making arrangement 42 and the third contact-making arrangement 43. In a prototype with a winding number of 22 windings per stator coil 28, the resistance between each two adjacent contact-making arrangements 41, 42, 43 was approximately 106 mΩ (milliohm). The maximum difference of the resistance was 0.5 mΩ. This results in a deviation of less than 0.5%, which also corresponds to a corresponding difference of the wire lengths. Differences in the wire lengths of less than 3% are already satisfactory. At less than 2%, the winding arrangement also works excellently, at least in the case of rotational speeds that are not excessively high. Values of less than 1% or less than 0.5% are excellent and suitable for high-performance drives.

The contact-making arrangements 41, 42, 43 do not have to be arranged offset by exactly 120° in each case; however, they are preferably arranged offset by at least 110° with respect to one another, for example, 110°, 120° and 130°.

Considering the contact elements 51, 52, 53, an arrangement of the contact-making arrangements 41, 42, 43 distributed over the circumference can be described so that the contact elements 51, 52, 53 are distributed on the wire guiding arrangement 40 are distributed in such a manner that a subdivision of the wire guiding arrangement 40 into three sections of 120° is possible, wherein a contact element 51, 52, 53 is provided in each of the sections. In the represented stator arrangement 20, for example, one can choose to have a first section from the center of the stator coil 28F to the center of the stator coil 28B. A second section can be chosen from the center of the stator coil 28B to the center of the stator coil 28D. A third section can be chosen from the center of the stator coil 28D to the center of the stator coil 28F.

In the embodiment example, the wire guiding arrangement 40 has, in addition to the contact-making arrangements 41, 42, 43, additional winding posts 46. The winding wire 26 lies against or around the post which the winding wire is guided. Thus, this enables a guiding of the winding wire 26 between the stator coils 28 or between the contact-making arrangements 41, 42, 43 and the contact elements 51, 52, 53. Due to the position of the winding posts 46, the wire length of the winding wire 26 can be influenced. Thus, a winding post 46, for example, in the CAD system, can be offset farther inward or farther outward for the adjustment of the wire lengths between the contact elements 51, 52, 53. Preferably, the winding posts 46 are also used as hold-down devices. They limit axial movement of the winding wire 26 during the winding process. Thus, this prevents the winding wire 26 from slipping off during the winding process.

Preferably, the contact-making arrangements 41, 42, 43 are arranged neither centrally with respect to one of the stator poles 32 nor centrally with respect to one of the slots 34. This has the advantage that the winding wire 26 can run from the respective contact-making arrangement 41, 42, 43 directly into the slot 34. In contrast, in a central arrangement with respect to the slot 34, the winding wire 26 would run during the winding process at a slant through the slot to the respective stator pole 32 and take up unnecessary space. A central arrangement with respect to the stator pole 32 would result in a slanted course in the run between the contact-making arrangement 41, 42, 43 and the associated stator pole 28, and this is disadvantageous during the winding process with a needle winder and leads to a longer wire length.

In the contact-making arrangements 42 and 43, the winding wire 26 is guided in such a manner that, after the winding of one of the stator poles 32, it is guided from radially outside to radially inside in the corresponding contact-making arrangement 42, 43. This is advantageous since the winding wire 26 on the radially inner side can be guided directly to the formation of the stator coil 28. This results in short paths. The guiding of the winding wire 26 from radially outside to radially inside does not mean that the winding wire 26 has to extend exactly in radial direction. Instead, it means that it has to run from farther outside to farther inside, this can also occur at a slant.

In the contact-making arrangement 41, preferably both wire ends of the winding wire 26 are on the radially outer side. Thus, cutting off the winding wire 26 after the winding process is facilitated. Accordingly an incorrect cutting off of the winding wire 26 is prevented. In the embodiment example, a wound through winding wire 26 is shown. Alternatively, it is possible to provide two or more winding wires that are wound through. Preferably, the winding wires can be wound together. Thus, a difference in the wire lengths is reduced. In the case of a bifilar winding, the winding is wound, for example, in pairs.

FIG. 4 shows the second axial side 72 opposite the first axial side 71 (compare FIG. 5) of the stator arrangement 20. An end plate 49 is provided. Preferably, it is designed to form a single piece with the wire guiding arrangement 40 and the slot insulation 48. The formation can occur, for example, by an injection molding process, or by another forming method. Alternatively, the wire guiding arrangement 40 and the end plate 49 can be designed as half shells. Thus, in each case they form an area of the slot insulation. It is also possible to provide the wire guiding arrangement 40, the end plate 49 and the slot insulation 48 as separate components.

FIG. 5 shows the stator arrangement 20 in a side view. The contact-making arrangements 41, 42, 43 with the contact elements 51, 52, 53 as well as the winding posts 46 protrude in axial direction from the stator core 22. The formation of the winding posts 46 as hold-down can be seen. For this purpose, a slot for guiding the winding wire 26 is provided on the radially outer side.

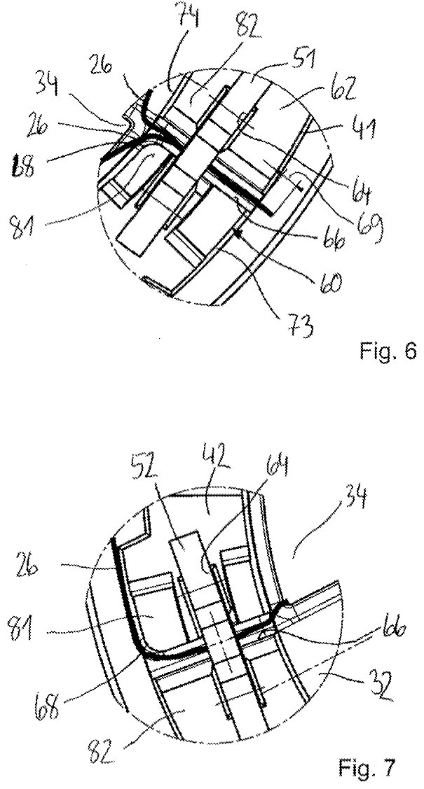

On the contact-making arrangements 41, 43, sliding surfaces 68 can be seen, that are described in FIG. 6 to FIG. 9.

FIG. 6 shows the detail VI of FIG. 3. The contact-making arrangement 41 has a first receiving opening 64, to receive the contact element 51, and a second receiving opening 66, to receive the winding wire 26. The second receiving opening 66 can also be referred to as groove or slot. The winding wire 26 or multiple winding wires 26 can be inserted in the opening. In a second step, the contact element 51 is inserted into the first receiving opening 64. The first receiving opening 64 can also be referred to as a pocket. Preferably, the first receiving opening 64 is designed at least in sections so as to pass at least in sections through the second receiving opening 66. Thus, the insulation displacement contact 51 can be mounted in one step and, at the same time, the insulation displacement connection with the winding wire(s) 26 can be made.

The passage angle is preferably 90°; however, it can also be, for example, 85° or 60°. To the extent that for the contact element 51, another technique (for example, a soldering technique) is used, another design is preferably possible. The contact-making arrangement 41 preferably has a housing section 60 with a plug-in surface 62. On the side of the plug-in surface 62, the contact element 51 can be inserted into the contact-making arrangement 41. Preferably, the contact-making arrangement 41 has a first side surface 73 (for example, radially outside) and/or a second side surface 74 (for example, radially inside). When both the first side surface 73 and the second side surface 74 are provided, the second receiving opening preferably extends between the first side surface 73 and the second side surface 74.

In the embodiment example, two free wire ends of the winding wire 26 are arranged on the radially outer side of the contact-making arrangement 41. The excess length 69 of the winding wire 26, in the area of the winding wire ends, is preferably at most 0.8 mm. On the one hand, this allows a satisfactory cutting off. On the other hand, this reduces the risk that a winding wire end on the radially outer side leads to a short circuit with another electrically conductive component. A preferred excess length is in the range 0.5±0.3 mm.

The sliding surface 68 is rounded in order to enable a sliding of the winding wire 26 along the sliding surface during the winding process. Thus, in the process it reduces the risk of a tearing off of the winding wire 26.

The contact-making arrangement 41, a first side 81 of the second receiving opening 66 and a second side 82 of the second receiving opening 66. The second side 82 is opposite the first side 81 in the drawing.

The other contact-making arrangements 42, 43 can be of identical or different design.

FIG. 7 shows the detail VII of FIG. 3 with the contact-making arrangement 42. Below, the preferred differences with respect to the contact-making arrangement 41 from FIG. 6 are discussed. During the winding, the winding wire is guided from the radially outer side of the contact-making arrangement through the second receiving opening 66 to radially inside and runs further into the slot 34. In a monofilar winding arrangement, only one winding wire in the area of the second receiving opening 66 is provided. It is contacted by the contact element 52. The sliding surface 68 is on the radially outer side. Thus during the winding, the winding wire is fed on the radially outer side.

The contact-making arrangement 42 includes a first side 81 of the second receiving opening 66 and a second side 82 of the second receiving opening 66. The second side 82 is opposite the first side 81.

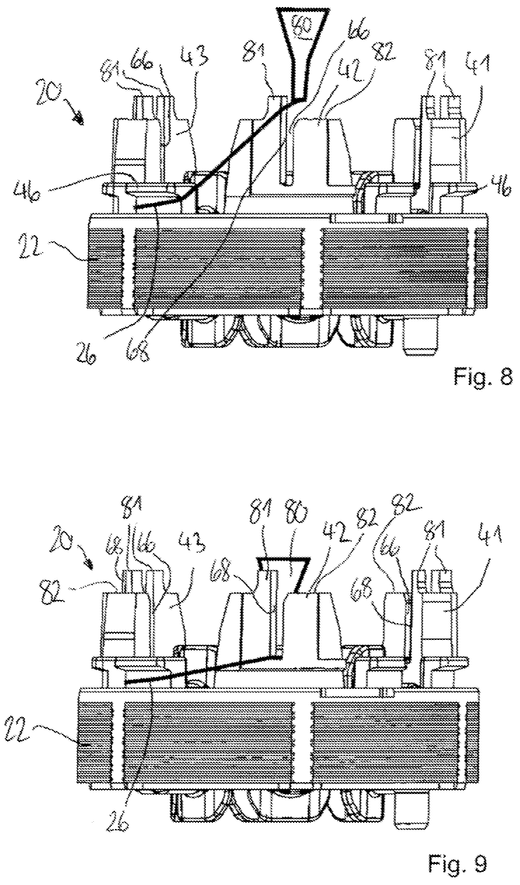

FIG. 8 shows a winding process with the winding wire 26 on the second contact-making arrangement 42, in a diagrammatic representation. The winding wire 26 is guided around the winding post 46. From there the wire 26 is guided on the radially outer side of the second contact-making arrangement 42 to the arrangement. The winding post 46 is designed as a hold-down device. Thus the hold-down device can be implemented at an axially low position, without the winding wire 26 slipping off the hold-down device in the process.

On the first side 81 of the second receiving opening 66, the contact-making arrangement 42 extends in an axial direction farther away from the stator core 22 than on the second side 82 opposite the first side 81. Thus, the needle winder 80 can be guided along from the winding post 46 on the radially outer side of the stator arrangement 20, until it is in the area of the second contact-making arrangement 42 in the vicinity of the second receiving opening 66. From there, the needle winder 80 can be moved radially inward. In the process, the winding wire 26 is captured on the first side 81 by the contact-making arrangement 42. Thus, it does not slip off the contact-making arrangement 42. Accordingly, by the axially longer design on the first side 81 provides, a kind of threading aid.

As can be seen in FIG. 8, the additional extension in the axial direction on the first side 81 of the second receiving opening 66 is provided on both sides of the first receiving opening 64. This reduces the risk of an incorrect threading of the winding wire into the second receiving opening 66. Also, it simplifies the introduction of the winding wire 26.

FIG. 9 shows how the winding wire 80 is moved in the radially inner area of the stator arrangement 20 downward or into the stator arrangement 20. During this movement of the needle winder 80, the winding wire 26 slides along the sliding surface 68 into the second receiving opening 66 for the winding wire 26. The sliding surface 68 is preferably rounded. On the one hand, this enables satisfactory sliding of the winding wire 26 in the longitudinal direction. On the other hand, it prevents destruction of the winding wire 26 or of an optionally provided enamel layer.

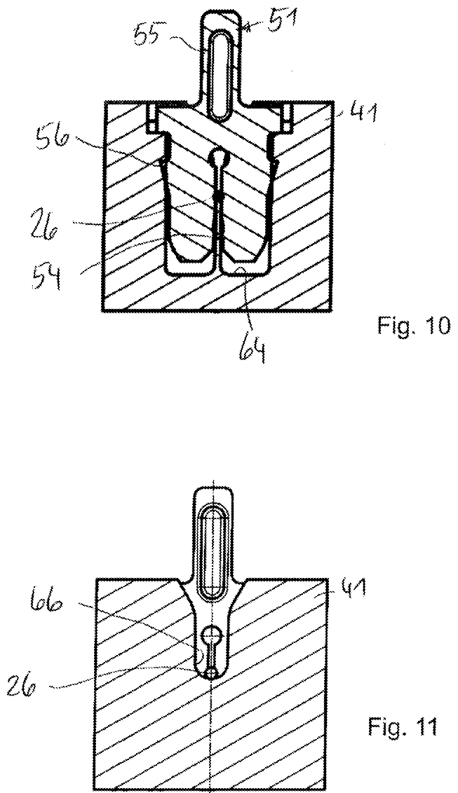

FIG. 10 shows a longitudinal section through an additional embodiment of the contact element 51. FIG. 11 shows a cross section that is offset parallel relative to the longitudinal section of FIG. 10, outside of the first receiving opening 64. From these figures, the mode of operation of the contact element 51 for contacting the winding wire 26 results. The winding wire 26 runs along the second receiving opening 66. The contact element 51 is inserted from the top into the first receiving opening 64. The contact element 51 has a slit 54. During the plugging in of the contact element 51 into the first receiving opening 64, the winding wire 26 is introduced into the slit 54. In other words, the contact element 51 clasps the winding wire 26 with the aid of the slit 54 in the manner of a pincer. The winding wire 26 usually has an electrical insulation, for example, an external enamel layer or another plastic insulation layer. Thus, no short circuit occurs between the individual windings of the stator coils 28. The insulation layer is rubbed off by the shifting of the winding wire 26 along the slit 54. An electrical connection is formed between the winding wire 26 and the contact element 51. The contact element 51 preferably has barbs 56 in order to prevent falling out after the installation of the contact element 51. In the embodiment example, the contact element 51 has a pin 55 via which a connection can be made, for example, to an output stage with power semiconductors.

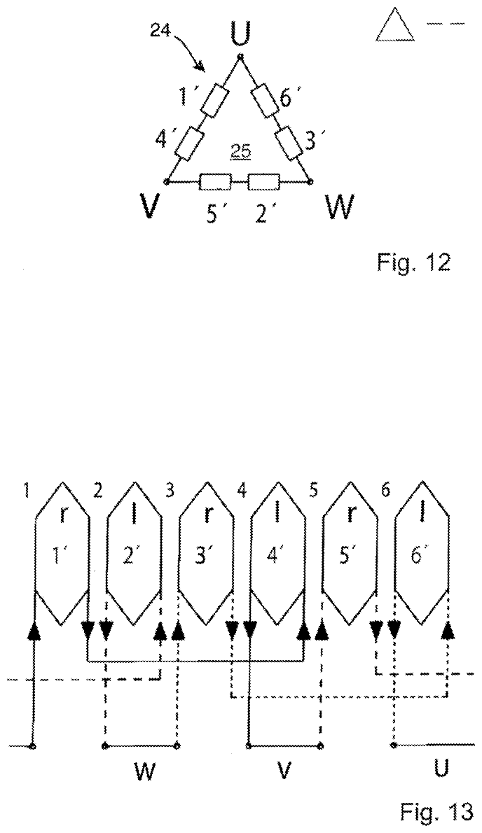

FIG. 12 shows the wiring plan of the winding arrangement 24 in a circuit diagram. This already described circuit can be referred to as a delta series circuit.

FIG. 13 shows an additional diagrammatic representation of the wiring plan of the winding arrangement 24. It illustrates the winding direction on the individual stator poles.

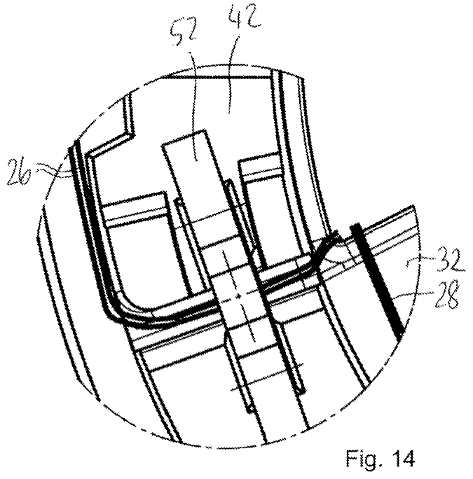

FIG. 14 shows the detail of FIG. 7 but with a bifilar winding. Thus, two winding wires 26 are wound in parallel or in pairs. Accordingly, they are wound at the same time by the needle winder.

Naturally, various variations and modifications are possible in the context of the present application.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1.-18. (canceled)

19. A stator arrangement has a stator core, a wire guiding arrangement and a winding arrangement with a winding wire and is designed as an external stator arrangement, comprising:
a winding arrangement with a delta circuit and a number SC of stator coils: SC=N*3 where N=1, 2, 3, 4, 5, . . . ;
the stator core has a magnetic return path, stator poles and slots that are formed between the stator poles;
the wire guiding arrangement has an associated first contact-making arrangement with a first contact element, an associated second contact-making arrangement with a second contact element, and an associated third contact-making arrangement with a third contact element;
the winding wire runs, without interruption, from the first contact-making arrangement, via at least one of the stator coils, to the second contact-making arrangement, from the second contact-making arrangement, via at least one of the stator coils, to the third contact-making arrangement, and from the third contact-making arrangement, via at least one of the stator coils, to the first contact-making arrangement;
the contact elements are electrically connected to the winding wire in order to serve as winding connections;
at least one of the contact-making arrangements has a first receiving opening to receive the contact element and a second receiving opening for receiving the winding wire; and
on a first side of the second receiving opening, at least one of the contact-making arrangements extends in an axial direction farther away from the stator core than on the second side opposite the first side to enable, during the winding of the winding wire, a capture of the winding wire.

20. The stator arrangement according to claim 19, wherein the contact-making arrangements are arranged offset by at least 110° with respect to one another, preferably 120°.

21. The stator arrangement according to claim 19, wherein the contact elements are distributed on the wire guiding arrangement such that a subdivision of the wire guiding arrangement into three sections of 120° is possible, and one of the contact elements is provided in each of the sections.

22. The stator arrangement according to claim 19, wherein the electrical resistances existing between two of the contact elements differ from one another by less than 3%, preferably by less than 2%, more preferably by at least 1% and more preferably by at least 0.5%.

23. The stator arrangement according to claim 19, wherein the contact-making arrangements are, at least in part, arranged neither centrally with respect to one of the stator poles nor centrally with respect to one of the slots.

24. The stator arrangement according to claim 19, wherein the winding wire is guided in sections so that, after the winding of one of the stator poles, it is guided in one of the contact-making arrangements from radially outside to radially inside.

25. The stator arrangement according to claim 19, wherein the second receiving opening of the contact-making arrangement extends in a radial direction.

26. The stator arrangement according to claim 19, wherein the first receiving opening extends in an axial direction of the stator arrangement.

27. The stator arrangement according to claim 19, wherein the first receiving opening extends in a direction of the stator arrangement that deviates from the axial direction.

28. The stator arrangement according to claim 19, wherein the first receiving opening is designed at least in sections to pass through the second receiving opening.

29. The stator arrangement according to claim 19, wherein the number N is at least 2, and wherein the winding wire runs between the contact-making arrangements via at least two of the stator coils.

30. The stator arrangement according to claim 29, wherein the winding wire between the contact-making arrangements connects at least two of the stator coils in series.

31. The stator arrangement according to claim 19, wherein the first contact element, the second contact element and the third contact element are designed as insulation displacement contact elements.

32. The stator arrangement according to claim 19, wherein at least two of the contact-making arrangements are identical.

33. The stator arrangement according to claim 19, wherein the first contact element, the second contact element and the third contact element are identical.

34. The stator arrangement according to any one of the preceding claims, wherein at least two winding wires are provided, that are wound together.

35. The stator arrangement according to claim 19, wherein the wire guiding arrangement has at least one winding post, against which the winding wire lies in order to enable a guiding of the winding wire (26) and an influencing of the length of the winding wire between two contact elements.

36. An electric motor with a stator arrangement according to claim 19 and with a rotor arrangement.
